(19) United States
(12) Patent Application Publication
(10) Pub. No.: US 2018/0347276 A1
(43) Pub. Date: Dec. 6, 2018

(54) Tree Ladder

(71) Applicant: Kary Zarem, Myakka City, FL (US)

(72) Inventor: Kary Zarem, Myakka City, FL (US)

(21) Appl. No.: 15/982,577

(22) Filed: May 17, 2018

Related U.S. Application Data
(60) Provisional application No. 62/512,262, filed on May 30, 2017.

(51) Int. Cl. E06C 1/34; E06C 1/12; E06C 7/06; E06C 7/42

(52) U.S. Cl. CPC E06C 1/34; E06C 7/42; E06C 7/06; E06C 1/12

(57) ABSTRACT

A ladder that removably secures to a tree. The tree ladder includes a pair of opposing siderail members, each siderail member having an upper end and a lower end, with a plurality of rungs between the pair of siderail members. A mounting rung at the upper end of the tree ladder has an arcuate shape designed to fit around part of a tree trunk. The mounting rung has a plurality of teeth on an inner edge which are designed to secure to the tree trunk. In this way, the tree ladder can be secured to the tree and an individual can safely climb the tree.

### CROSS REFERENCE TO RELATED APPLICATIONS

This application claims the benefit of U.S. Provisional Application No. 62/512,262 filed on May 30, 2017. The above identified patent application is herein incorporated by reference in its entirety to provide continuity of disclosure.

### BACKGROUND OF THE INVENTION

The present invention relates to tree ladders. More specifically, the present invention provides a pair of opposing siderail members, each siderail member having an upper end and a lower end, with a plurality of rungs disposed therebetween. A mounting rung at the upper end of the tree ladder has an arcuate shape configured to fit a tree trunk, with a plurality of teeth disposed on an inner edge of the mounting rung configured to secure to the tree.

Ladders are inherently risky, and when one person is using a ladder it is often recommended a second person hold the lower end of the ladder to help provide stability, thereby preventing the ladder from falling and injuring anyone. Unfortunately, many people use ladders alone, and do not have the time or resources to find a second person to hold the lower end of the ladder. Additionally, ladders can be especially risky when working on tree maintenance, such as trimming branches, as the rounded nature of the tree trunk makes it difficult for the straight rung of a ladder to securely rest against the tree trunk. Thus, an improved tree ladder is desired to allow a single individual to climb a ladder that is safely secured against a tree.

### SUMMARY OF THE INVENTION

In view of the foregoing disadvantages inherent in the known types of tree ladders now present in the known art, the present invention provides a tree ladder wherein the same can be utilized for providing convenience for the user when attempting to safely climb a tree.

It is therefore an object of the present invention to provide a new and improved tree ladder device that has all of the advantages of the known art and none of the disadvantages. The present system comprises a pair of opposing siderail members, each siderail member having an upper end and a lower end, with a plurality of rungs disposed therebetween the pair of siderail members. A mounting rung is disposed at the upper end of the tree ladder and has an arcuate shape configured to fit flush against a tree trunk. A plurality of teeth is disposed on an inner edge of the mounting rung and configured to secure to the tree trunk. In this way, the tree ladder is secured to the tree and an individual can safely and efficiently climb the tree.

In one embodiment, one or more ground fasteners are disposed at the lower end of each siderail member and configured to secure the lower end of each siderail member to the ground. In another embodiment, a tree fastener is disposed at the upper end of the siderail members and configured to secure the upper ends of the siderail members to the tree. In one embodiment, the plurality of rungs further comprise rubber grips disposed on an upper side of each rung. In another embodiment, the ground fasteners comprise a stake. In a further embodiment, the stakes are slidably attached to the lower end of each siderail member, such that the stakes can be maintained in a retracted position, wherein the retracted position comprise the stakes unsecured to the ground. In one embodiment, the ground fasteners are disposed on an inner side of the lower end of each siderail member. In another embodiment, the pair of opposing siderail members are telescopic. In a further embodiment, the plurality of teeth each comprise a triangular cross section. In one embodiment, the plurality of teeth is disposed at equal intervals along the inner edge of the mounting rung. In another embodiment, the plurality of teeth further comprise a rubber coating disposed thereon, such that the plurality of teeth is configured to frictionally engage the tree without harming the bark. In an alternate embodiment, the mounting rung is configured to rotate. In one embodiment, the tree fastener comprises a cord with a first end and a second end, each end secured to a siderail member, such that the cord is configured to be tightened. In a further embodiment, grips are disposed on the lower end of each siderail member to further grip the ground. In another embodiment, handles are disposed on the upper end of the tree ladder.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tree ladder.

FIG. 2 shows a close-up view of an embodiment of the ground fasteners securing the lower end of the tree ladder to the ground.

FIG. 3A shows a close-up view of an embodiment of the mounting rung and tree fastener.

FIG. 3B shows a close-up view of an embodiment of the mounting rung rotating and tree fastener tightening.

FIG. 4 shows a close-up view of an embodiment of the tree ladder in use.

FIG. 5 shows a perspective view of an embodiment of the tree ladder retracted.

### DETAILED DESCRIPTION OF THE INVENTION

Reference is made herein to the attached drawings. Like reference numerals are used throughout the drawings to depict like or similar elements of the tree ladder. The figures are intended for representative purposes only and should not be considered to be limiting in any respect.

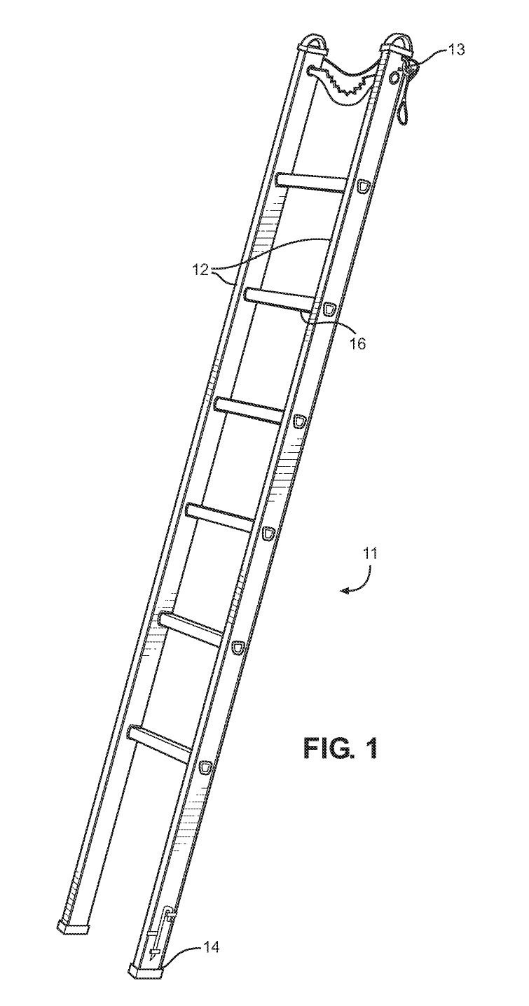

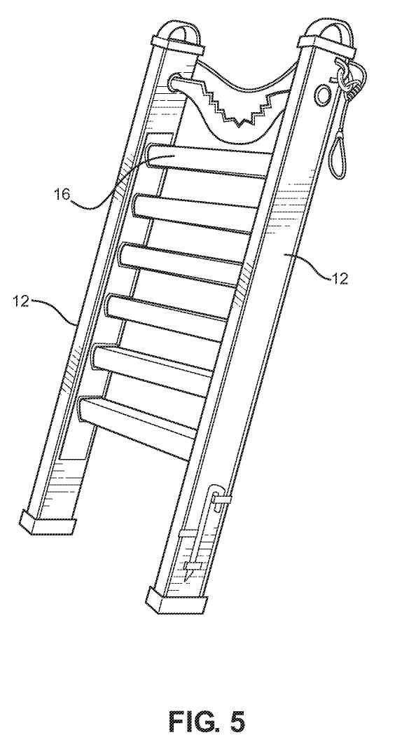

Referring now to FIG. 1 and FIG. 5, there is shown a perspective view of the tree ladder, and a perspective view of the tree ladder retracted. A tree ladder 11 comprises a pair of opposing siderail members 12, wherein each siderail member 12 has an upper end 13 and a lower end 14. A plurality of rungs 16 are disposed therebetween the pair of siderail members 12. In the shown embodiment, the plurality of rungs 16 are disposed at even intervals therebetween the siderails 12, however in other embodiments the plurality of rungs 16 are disposed at uneven intervals therebetween. The plurality of rungs 16 are configured to support a person climbing the ladder. In one embodiment, the pair of opposing siderail members 12 are telescopic, such that the tree ladder 11 is configured to move between an extended position and a retracted position, wherein each distal end of each rung of the plurality of rungs 16 is slidably disposed within a channel on an inner side of the siderail members. In this way, the plurality of rungs 16 are stackably disposed atop one another in the retracted position. A length of the tree ladder 11 in the retracted position is less than the length of the tree ladder 11 in the extended position.

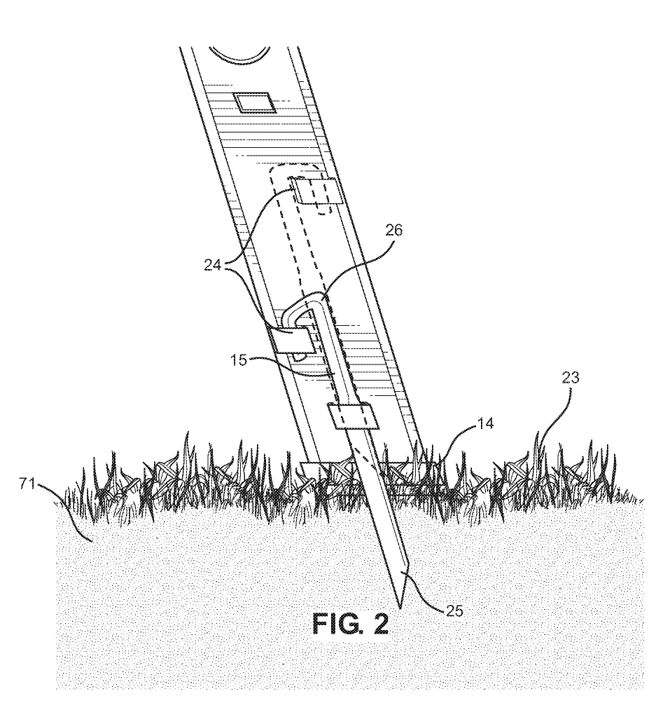

Referring now to FIG. 2, there is shown a close-up view of the ground fasteners securing the lower end of the tree ladder to the ground. In one embodiment, the lower end 14 of each siderail member comprises a grip 23 on the portion of the siderail member flush with the ground 71, such that the lower end 14 is further stabilized when secured to the ground 71. In the illustrated embodiment, the grip 23 comprises rubber, such that the lower end 14 frictionally engages with the ground 71. In the shown embodiment, one or more ground fasteners 15 are disposed at the lower end 14 of each siderail member, wherein the ground fasteners 15 are configured to secure the lower end 14 of each siderail member to the ground 71. In this way, the tree ladder is removably secured to the ground 71. In one embodiment, the ground fasteners 15 are disposed on an inner surface of the lower end 14 of each siderail member.

In a further embodiment, the ground fastener 15 comprises a stake, having a tapered end that comes to a point 25, such that the point 25 can be driven into the ground 71. Additionally, the stake 15 has a hooked end 26 configured to secure the stake 15 to one or more bands 24 disposed on the inner surface of each siderail member. In this embodiment, the stakes 15 are slidably attached to the lower end 14 of each siderail member, such that the hook 26 is configured to secure the stake 15 in a retracted position, wherein the retracted position comprises the hook 26 removably secured to a band 24 such that the stake 15 is not secured in the ground 71. In the extended position, the point 25 of the stake 15 is extended past the lower end 14 of the siderail member to penetrate the surface of the ground 71.

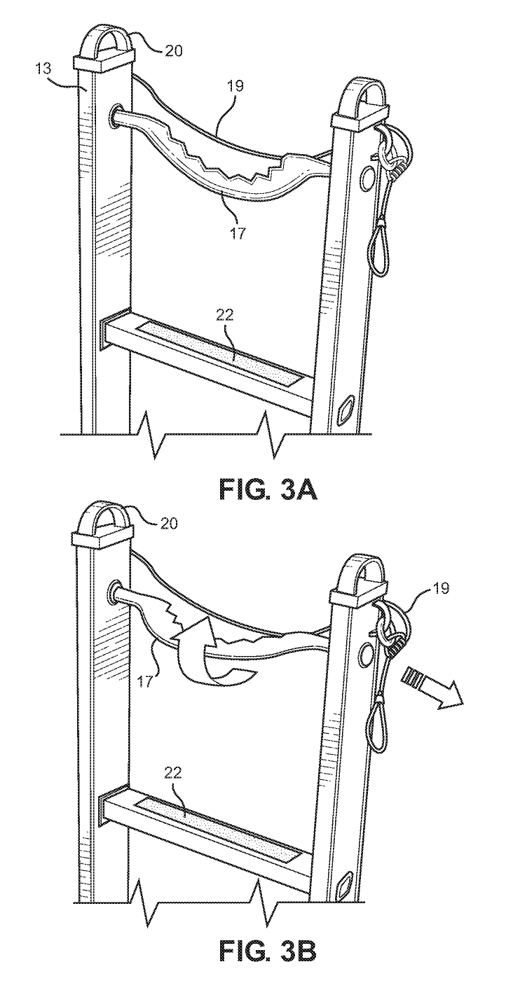

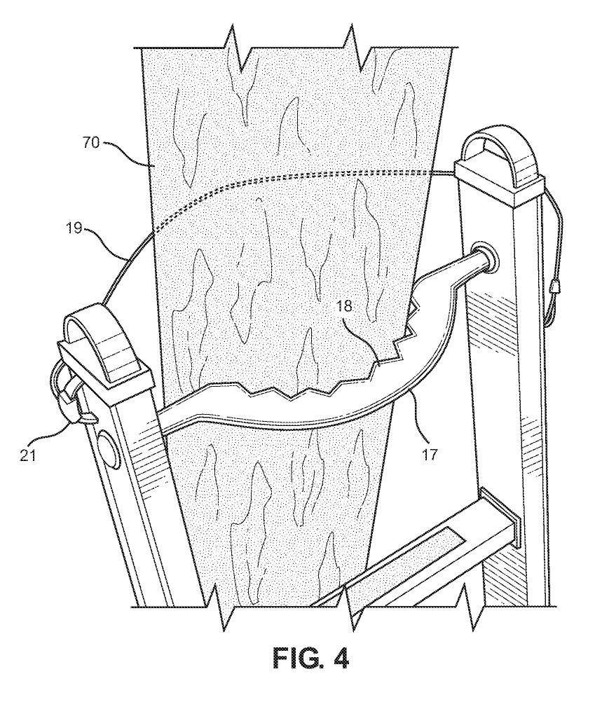

Referring to FIG. 3A, FIG. 3B, and FIG. 4 there are shown close-up views of the mounting rung and tree fastener, the mounting rung rotating and tree fastener tightening, and a close-up view of the tree ladder in use, respectively. The tree ladder further comprises a mounting rung 17 disposed at the upper end 13 of the siderail members and having an arcuate shape configured to fit the rounded shape of a tree trunk. In the shown embodiment, the mounting rung 17 further comprises a pair of distal portions rotably secured to each respective pair of opposing siderail members, the pair of distal portions aligned to form a first axis therealong. A middle section is disposed between the pair of distal portions and curved so as to be offset from the first axis when engaged to a received tree 70. In this way, the mounting rung 17 is configured to partially enclose the trunk of the tree 70. In the illustrated embodiment, the mounting rung 17 is the uppermost rung of the tree ladder. However, in other embodiments, the mounting rung 17 is the penultimate rung at the upper end 13 of the siderails.

A plurality of teeth 18 is disposed on an inner edge of the mounting rung 17, wherein the plurality of teeth 18 are configured to secure to a tree 70. In the embodiment wherein the mounting rung 17 is pivotally secured to the siderail members such that the mounting rung 17 is configured to rotate freely, the plurality of teeth 18 are configured to secure to the tree from an angle other than ninety degrees. Thereby, the tree ladder is further secured to the tree 70. In another embodiment, the plurality of teeth 18 each comprise a triangular cross section, such that each tooth has a point, wherein each point is configured to secure to the tree 70. In other embodiments, each tooth of the plurality of teeth 18 comprise a squared cross section. In a further embodiment, the plurality of teeth 18 are disposed at equal intervals along the inner edge of the mounting rung 17, such that the plurality of teeth 18 are evenly spaced along the inner edge of the mounting rung 17. In an additional embodiment, a rubber coating is disposed on each tooth of the plurality of teeth 18, wherein the rubber coating is disposed on an edge of each tooth configured to sit flush against the tree 70. In this way, the plurality of teeth 18 are configured to frictionally engage the tree 70 and thereby secure to the tree 70, such that there is less damage done to the bark of the tree 70.

In the shown embodiment, a tree fastener 19 is disposed at the upper end 13 of the siderail members, wherein the tree fastener 19 is configured to secure each upper end 13 of the siderail members to the tree 70, such that the tree ladder itself is fully secured to the tree 70, and the tree 70 is fully enclosed by the tree fastener 19 and the mounting rung 17. In one embodiment, the tree fastener 19 comprises a cord having a first end and a second end, wherein the second end is slidably secured to the upper end of one of the siderail members such that the cord is configured to be tightened, and thereby secure to the tree 70. In a further embodiment, a loop 21 is disposed on an outer edge of each siderail member, wherein the cord 19 is configured to secure to each loop 21. Additionally, the second end of the cord 19 is configured to removably secure to the loop 21, such that the cord 19 is configured to wrap around the tree 70, and in this way further secure the tree ladder to the tree 70.

In an additional embodiment, a rubber grip 22 is disposed on an upper surface of each rung of the plurality of rungs disposed between each siderail member, such that the rubber grip 22 provides a frictional resistance against the shoes of an individual climbing the tree ladder, thereby preventing slipping. In this way, the rubber grips 22 increase the safety and efficacy of the tree ladder. In a further embodiment, handles 20 are disposed on a distal edge of the upper end 13 of each siderail member. In this way, a user sitting in a tree 70 can easily grasp the handles 20 and reposition the tree ladder or rotate it about the tree 70 without climbing down the tree ladder and repositioning from the ground.

In operation, an individual takes the tree ladder and sets it up, such that the lower end is flush against the ground, and the upper end is flush against a tree. The mounting rung of the tree ladder, having an arcuate shape and disposed at the upper end of the tree ladder, is configured to rest flush against the curved tree, such that the mounting rung partially encloses the trunk of the tree. A plurality of teeth disposed on the inner edge of the mounting rung additionally secure the mounting rung to the tree. In one embodiment, the individual then secures the tree fastener around the trunk of the tree, such that the trunk is fully closed by both the tree fastener and mounting rung. In this way, the tree ladder is fully secured to the tree, and the individual can safely climb the tree ladder to trim or provide other maintenance to the tree.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tree ladder, comprising:
a pair of opposing siderail members, each siderail member having an upper end and a lower end;
a plurality of rungs disposed between the pair of siderail members;
a mounting rung disposed at the upper end of the tree ladder, the mounting rung having an arcuate shape with a plurality of teeth disposed on an inner edge thereof;
wherein the plurality of teeth is configured to secure to a tree.

2) The tree ladder of claim 1, wherein the plurality of rungs further comprise rubber grips disposed on an upper side of each rung.

3) The tree ladder of claim 1, wherein one or more ground fasteners are disposed at the lower end of each siderail member configured to secure the lower end of each siderail member to the ground.

4) The tree ladder of claim 3, wherein the ground fasteners comprise a stake.

5) The tree ladder of claim 4, wherein the stakes are slidably attached to the lower end of each siderail member, such that the stakes are maintained in a retracted position, wherein the retracted position comprises the stakes unsecured to the ground.

6) The tree ladder of claim 4, wherein the stakes are slidably attached to the lower end of each siderail member, such that the stakes are configured to extend to an extended position when sliding past the lower end of the tree ladder to penetrate a ground surface.

7) The tree ladder of claim 3, wherein the ground fasteners are disposed on an inner side of the lower end of each siderail member.

8) The tree ladder of claim 1, wherein the pair of opposing siderails are telescopic such that the tree ladder is configured to move between an extended position and a retracted position, wherein a length of the tree ladder in the retracted position is less than the length of the tree ladder in the extended position, and the plurality of rungs are slidably disposed within the siderails, such that the plurality of rungs are configured to compress to accommodate the retracted position.

9) The tree ladder of claim 1, wherein the plurality of teeth each comprise a triangular cross section.

10) The tree ladder of claim 1, wherein the plurality of teeth further comprise a rubber coating disposed thereon, such that the plurality of teeth is configured to frictionally engage the tree and thereby secure to the tree.

11) The tree ladder of claim 1, wherein the mounting rung further comprises:
a pair of distal portions rotably secured to each respective pair of opposing siderail members, the pair of distal portions aligned to form a first axis therealong;
a middle section disposed between the pair of distal portions and curved so as to be offset from the first axis when engaged to a received tree.

12) The tree ladder of claim 1, wherein the mounting rung is disposed as the uppermost rung.

13) The tree ladder of claim 11, wherein the plurality of teeth is oriented towards a center point of the middle section.

14) The tree ladder of claim 11, wherein the pair of distal portions are cylindrical.

15) The tree ladder of claim 1, wherein a tree fastener is disposed at the upper end of the siderail members, configured to secure the upper ends of the siderail members to the tree, such that the tree ladder is secured to the tree.

16) The tree ladder of claim 15, wherein the tree fastener comprises a cord having a first end and a second end, wherein the second end is slidably secured to the upper end of one of the siderail members, such that the cord is configured to encircle a tree and be tightened therearound.

17) The tree ladder of claim 16, wherein each siderail member has a loop disposed on an outer side at the upper end, such that the first end and second end of the cord are each configured to secure to opposing loops.

18) The tree ladder of claim 1, wherein a grip is disposed on the lower end of each siderail member, wherein the grip is configured to sit flush against the ground when the tree ladder is against a tree.

19) A mounting rung comprising:
a pair of distal portions configured to secure to a pair of opposing siderail members of a ladder;
wherein the mounting rung has an arcuate shape with a plurality of teeth disposed on an inner edge thereof;
wherein the plurality of teeth is configured to secure to a tree.
